(19) United States
(12) Patent Application Publication
(10) Pub. No.: US 2018/0222245 A1
(43) Pub. Date: Aug. 9, 2018

(54) DUAL PURPOSE INK PEN

(71) Applicant: Roderick Hawkins, Moultrie, GA (US)

(72) Inventor: Roderick Hawkins, Moultrie, GA (US)

(21) Appl. No.: 15/423,942

(22) Filed: Feb. 3, 2017

(51) Int. Cl. B43K 29/00; F23Q 2/00

(52) U.S. Cl. CPC B43K 29/004; F23Q 2/00

(57) ABSTRACT

A dual purpose ink pen that includes: a top lighter portion; a bottom pen portion; a lighter at a distal end of the top portion; a fill valve at a midpoint of the pen, where the fill valve is adapted to receive fuel for the lighter; and an ink pen assembly in the bottom portion below the fill valve, where the ink pen assembly includes a trigger.

### BACKGROUND OF THE INVENTION

### Field of Invention

The present invention relates to an ink pen that includes a lighter in addition to an ink pen assembly.

### Description of Related Art

Ink pens are a common writing utensil that is used for writing purposes. The typical ink pen includes an ink cartridge and a point for writing. The ink pen also normally may include a pocket clip to transfer with the pen during non-use. Dual purpose pens have been developed over many years, wherein the ink pen in addition to providing a writing utensil is also used for an additional purpose such as a lighter as disclosed in U.S. Pat. No. 2,308,225 to Edenburg. In this particular patent, a frictional lighter is provided at the top portion of the pen disclosed in the Edenburg. Another dual purpose ink pen is disclosed in Berkowitz, U.S. Pat. No. 2,607,883. This particular dual purpose ink pen includes a writing utensil in addition to a flashlight at the distal end of the ink pen. Shklovsky also discusses a combined writing utensil and lighter and includes a barrel housing, where the lighter and ink pen are integrated within a single cartridge along the left of the writing utensil. The lighter is provided at the top of the ink pen with a frictional striking force and a side trigger to release the ink pen at the bottom of the writing utensil.

Although the variations described above exist, further improvement of this particular concept is necessary to provide a lighter and ink pen in completely separate compartments. It is noted that the compartments of the prior art discussed above are shared and therefore certain aspects of the individual components are lacking essential features.

### SUMMARY OF THE INVENTION

The present invention relates to a dual purpose ink pen that includes: a top lighter portion; a bottom pen portion; a lighter at a distal end of the top portion; a fill valve at a midpoint of the pen, where the fill valve is adapted to receive fuel for the lighter; and an ink pen assembly in the bottom portion below the fill valve, where the ink pen assembly includes a trigger.

### BRIEF DESCRIPTION OF DRAWINGS

FIG. 1 depicts a dual purpose ink pen in accordance with the present invention.

### DETAILED DESCRIPTION

The present invention relates to a dual purpose ink pen-lighter that has a lighter within the top portion of the utensil. At the bottom portion of the utensil is the writing instrument in the form of an ink pen. These components are joined together to provide a positive dual purpose ink pen.

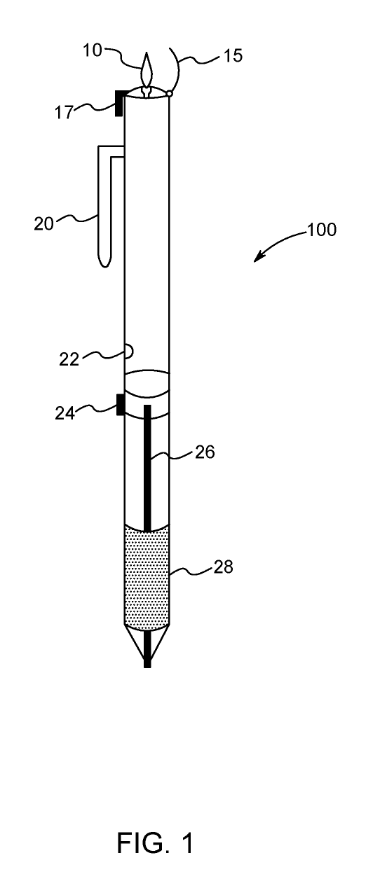

In reference to FIG. 1, a dual purpose ink pen 100 is depicted. This dual purpose ink pen 100 includes a cap 15 which covers a flame 10 at the top portion of the pen 100. Further a flame igniter 17 extends from the top edge of the lighter portion of the ink pen 100. The lighter further includes a fill valve 22 that allows a user to refill the lighter with fuel for ignition purposes. A pocket clip 20 is provided on one side of the lighter portion. The bottom portion of the ink pen 100 is an ink writing utensil that includes an ink cartridge 26 on the interior extending out to the point at the bottom of the ink pen 100. An ink trigger 24 is also provided that triggers the cartridge 26 into an extended position for writing purposes. The ink trigger 24 also retracts the ink cartridge 26 in a closed position within the bottom portion of the ink pen 100. A grip 28 extends around the exterior of the ink pen 100 for gripping purposes.

This present invention provides a utensil that includes a lighter and ink pen into discrete portions of the composite utensil. This clear separation allows for the refilling capabilities of the fill valve 22 as opposed to the disclosure of the above-referenced prior art. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A dual purpose ink pen comprising:
a top lighter portion, wherein the top lighter portion includes a cap and a pocket clip;
a bottom pen portion;
a lighter at a distal end of the top portion;
a fill valve at a midpoint of the pen, where the fill valve is adapted to receive fuel for the lighter; and
an ink pen assembly in the bottom portion below the fill valve, where the ink pen assembly includes a trigger and an ink cartridge on the interior, wherein the trigger extends the cartridge to an extended position and retracts the ink cartridge to a closed position.

2. The dual purpose ink pen according to claim 1, further includes a grip surface surrounding the pen assembly in the bottom portion.

3. The dual purpose ink pen according to claim 1, where the lighter includes a flip top and a flame ignitor extending from an edge.

4. (canceled)
